(19) United States
(12) Patent Application Publication
(10) Pub. No.: US 2025/0292048 A1
(43) Pub. Date: Sep. 18, 2025

(54) PRINTING SYSTEM, PRINTER, AND PRINTING METHOD

(71) Applicants: Nanami TAKANO, Tokyo (JP); Daiki MARUMO, Kanagawa (JP); Masanori HIRANO, Kanagawa (JP)

(72) Inventors: Nanami TAKANO, Tokyo (JP); Daiki MARUMO, Kanagawa (JP); Masanori HIRANO, Kanagawa (JP)

(73) Assignee: Ricoh Company, Ltd., Tokyo (JP)

(21) Appl. No.: 19/071,068

(22) Filed: Mar. 5, 2025

(30) Foreign Application Priority Data
Mar. 14, 2024 (JP) 2024-039835

(51) Int. Cl. G06K 15/02; B41J 2/005; B41J 2/01; B41J 2/21

(52) U.S. Cl. CPC G06K 15/1823; B41J 2/0057; B41J 2/2117; B41J 2002/012

(57) ABSTRACT

A printing system includes a discharge device to discharge color ink and white ink to a medium, a controller to control the discharge device, and circuitry configured to obtain image data, color data of the medium, and density data of the white ink. In the printing system, the controller calculates a concealment ratio of the medium based on the color data of the medium and the density data of the white ink, calculates an amount of the white ink to be adhered to conceal the medium based on the calculated concealment ratio, reads at least one image parameter selected from an amount of the color ink to be adhered and the color data measurable by a colorimeter in the image data, performs a threshold determination for the read image parameter, and adjusts the amount of the white ink to be adhered based on a result of the threshold determination.

### CROSS-REFERENCE TO RELATED APPLICATION

This patent application is based on and claims priority pursuant to 35 U.S.C. § 119 (a) to Japanese Patent Application No. 2024-039835, filed on Mar. 14, 2024, in the Japan Patent Office, the entire disclosure of which is hereby incorporated by reference herein.

### BACKGROUND

### Technical Field

The present disclosure relates to a printing system, a printer, and a printing method.

### Background Art

Printers that adopt direct-to-film (DTF) printing have been proposed. Such printers that adopt the DTF printing apply coloring ink to a transfer base material such as a film to form an image to be transferred. For example, adhesive powder is applied to an image to be transferred, and the coloring ink on the film is transferred to a to-be-transferred material such as clothes.

In such printers that adopt the DTF printing and other kinds of printers that do not adopt the DTF printing, foundation or the like is formed with white ink to ensure robustness against washing or conceal a to-be-transferred material.

For the purposes of reducing the production cost when an image is formed on a medium, printing methods that use an adequate amount of white ink according to the color of an image, while sufficiently maintaining robustness against washing, have been proposed.

### SUMMARY

The present disclosure described herein provides to a printing system and a printing method. The printing system includes a discharge device to discharge color ink and white ink to a medium, a controller to control the discharge device, and circuitry configured to obtain image data, color data of the medium, and density data of the white ink. In the printing system, the controller calculates a concealment ratio of the medium based on the color data of the medium and the density data of the white ink, calculates an amount of the white ink to be adhered to conceal the medium based on the calculated concealment ratio, reads at least one image parameter selected from an amount of the color ink to be adhered and the color data measurable by a colorimeter in the image data, performs a threshold determination for the read image parameter, and adjusts the amount of the white ink to be adhered based on a result of the threshold determination. The printing method includes discharging color ink and white ink to a medium, controlling discharge of the color ink and the white ink, obtaining image data, color data of the medium, and density data of the white ink, calculating a concealment ratio of the medium based on the color data of the medium and the density data of the white ink, calculating an amount of the white ink to be adhered to conceal the medium based on the calculated concealment ratio, reading at least one image parameter selected from an amount of the color ink to be adhered and the color data measurable by a colorimeter in the image data, performing a threshold determination for the read image parameter, and adjusting the amount of the white ink to be adhered based on a result of the threshold determination.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A and FIG. 1B are diagrams each of which illustrates a printing system.

FIG. 2A and FIG. 2B are diagrams each of which illustrates how the amount of white ink to be adhered is controlled.

FIG. 3A is a flowchart of the processes executed by a printing system when a threshold determination is made for the amount of color ink to be adhered.

FIG. 3B is a flowchart of the processes executed by a printing system when a threshold determination is made for color data.

FIG. 4 is another diagram illustrating how the amount of white ink to be adhered is controlled.

FIG. 5 is another flowchart of the processes executed by a printing system when a threshold determination is made for color data and the amount of color ink to be adhered.

FIG. 6A and FIG. 6B are diagrams illustrating an undesired ink flow.

FIG. 7 is a diagram illustrating gradation processing.

FIG. 8 is another flowchart of the processes executed by a printing system.

FIG. 9 is another flowchart of the processes executed by a printing system.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers, or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

A printing system, a printer, and a printing method are described below with reference to the accompanying drawings. The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope.

### First Embodiment

In the present embodiment, ink is discharged onto a medium.

A printing system includes a discharge device to discharge color ink and white ink to a medium and a controller to control the discharge device. The printing system obtains image data, color data of the medium, and density data of the white ink. The controller calculates a concealment ratio of the medium based on the color data of the medium and the density data of the white ink, and calculates an amount of the white ink to be adhered to conceal the medium based on the calculated concealment ratio. The controller reads an image parameter given below in the image data, and performs a threshold determination for the read image parameter. The controller adjusts the amount of the white ink to be adhered based on a result of the threshold determination.

### Image Parameter

The image parameter is at least one image parameter selected from an amount of the color ink to be adhered and the color data measurable by a colorimeter.

A printer includes a discharge device to discharge color ink and white ink to a medium and a controller to control the discharge device. The printer obtains image data, color data of the medium, and density data of the white ink. The controller calculates a concealment ratio of the medium based on the color data of the medium and the density data of the white ink, and calculates an amount of the white ink to be adhered to conceal the medium based on the calculated concealment ratio. The controller reads an image parameter given below in the image data, and performs a threshold determination for the read image parameter. The controller adjusts the amount of the white ink to be adhered based on a result of the threshold determination.

### Image Parameter

The image parameter is at least one image parameter selected from an amount of the color ink to be adhered and the color data measurable by a colorimeter.

A printing method includes discharging, using a printer, color ink and white ink to a medium and controlling discharge of the color ink and the white ink. The printing method includes obtaining image data, color data of the medium, and density data of the white ink. The controlling includes calculating a concealment ratio of the medium based on the color data of the medium and the density data of the white ink, calculating an amount of the white ink to be adhered to conceal the medium based on the calculated concealment ratio, reading an image parameter given below in the image data, performing a threshold determination for the read image parameter, and adjusting the amount of the white ink to be adhered based on a result of the threshold determination.

### Image Parameter

The image parameter is at least one image parameter selected from an amount of the color ink to be adhered and the color data measurable by a colorimeter.

In the following description, a medium, a to-be-transferred medium, and a to-be-transferred material are used equivalently.

In the present embodiment, the concealment ratio of the medium is calculated based on the color data of a medium and the density data of white ink, and the amount of the white ink to be adhered to conceal the medium is calculated based on the calculated concealment ratio. An image parameter is read from the image data, and whether the read image parameter is equal to or less than a predetermined threshold is determined. The amount of the white ink to be adhered is adjusted based on the result of the determination.

When the concealment ratio of the medium is calculated based on the color data of a medium and the density data of white ink, the concealment ratio of the medium may be calculated using the formulas given below. In this formula, brightness L* indicates the whiteness.

(L*_white ink adhered portion)−(L*_to-be-transferred medium)/(L*_white ink adhered portion)

In this formula, K density* indicates the whiteness.

(K density*_white ink adhered portion)−(K density*_to-be-transferred medium)/(K density*white ink adhered portion)

The K density indicates the K density (visual density) of the spectral density. Visual density indicates the common logarithm of the reciprocal of a reflectance, which is weighted by the wavelength response characteristics of an eye.

The concealment ratio may be indicated by the difference in white color ΔE as given below, which is supposed to indicate the concealing properties or characteristics.
ΔE_{(target value in whiteness), (white ink adhered portion)}

In the present embodiment, the term “concealment ratio” is used. However, the ratio is not very important, and it is sufficient as long as the threshold of the concealment is specified by a numerical value.

For example, when the image parameter is equal to or less than a predetermined threshold, the printer discharges the white ink with the calculated amount of white ink to be adhered. Due to such a configuration, an appropriate amount of white ink can be applied to a portion of the medium that is affected by its color. Accordingly, the white ink usage is reduced, and the color tone of transferred images can be unified regardless of the type of media.

Terms such as “image formation,” “recording,” “printing,” “image printing,” and “fabricating” used herein can be used synonymously with each other. When an inkjet printer is adopted, the printing system may be referred to as, for example, an inkjet system.

Examples of the medium include any desired materials on which liquid can be adhered even temporarily, such as paper, thread, fiber, fabric, leather, metal, plastic, glass, wood, ceramic, construction materials (e.g., wallpaper or floor material), textiles for clothing, and signage.

The printing system includes a discharge device to discharge color ink and white ink to a medium and a controller to control the discharge device. In the printing system, the discharge device and the controller may be separated from each other, or the discharge device and the controller may be provided for the same device or apparatus.

Any system configuration may be adopted as desired. For example, the printing system may include a printer provided with a discharge device and a controller Alternatively, the printing system may include a printer provided with a discharge device and another device provided with a controller that controls the printer.

The printing system may or may not include an information processing device such as a personal computer (PC), tablet PC, or smartphone.

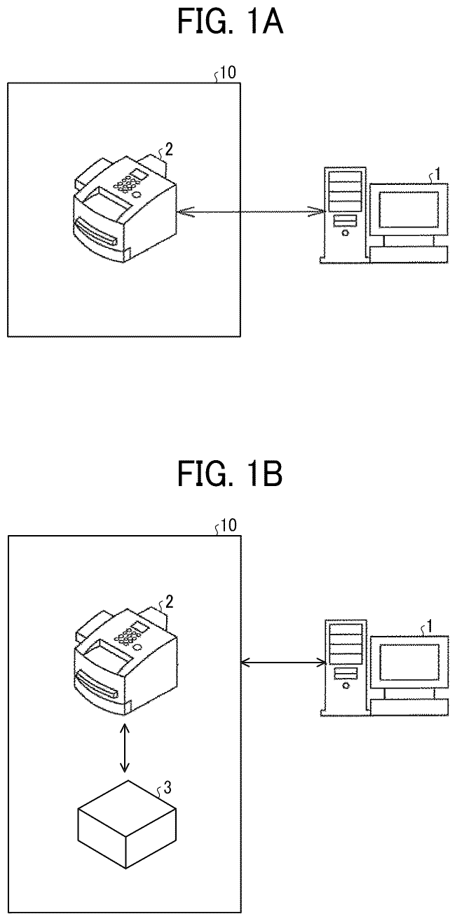

FIG. 1A and FIG. 1B are diagrams each of which illustrates the printing system 10. As illustrated in FIG. 1A, the printing system 10 may include an image forming apparatus 2 having a discharge device and a controller. In such cases, the image forming apparatus 2 may exchange data with the information processing device 1. As illustrated in FIG. 1B, the printing system 10 may include the image forming apparatus 2 having the discharge device and a control device 3 having a controller. In such cases, the printing system 10 may exchange data with the information processing device 1, or the control device 3 may exchange data with the information processing device 1.

Each of the information processing device 1, the image forming apparatus 2, and the control device 3 includes, for example, a central processing unit (CPU), a random access memory (RAM), a read-only memory (ROM), a hard disk drive (HDD), and interface (I/F) as desired.

For example, the discharge device includes a liquid discharge head such as an inkjet head. The liquid discharge head may be a single liquid discharge head or may include a plurality of liquid discharge heads. The discharge device may be a serial discharge device or an in-line discharge device.

The image forming apparatus 2 may include a conveyance unit that conveys a medium. The image forming apparatus 2 may include a heating unit that heats or dries the medium. Examples of the heating unit include a heater. The image forming apparatus 2 is an example of a printer.

The printing system 10 obtains the image data, the color data of the medium, and the density data of the white ink. Obtaining may be referred to as, for example, receiving, collecting, and accepting in the following description. These data may be obtained by the image forming apparatus 2, the control device 3, or other various kinds of apparatuses or devices. For example, the above data may be obtained from the information processing device 1. It is not always necessary for the data to be obtained through the Internet.

The printing system 10 according to the present embodiment may obtain the above data from a device other than the information processing device 1. For example, the color data of the medium may be obtained from a measuring device that measures the color of the medium as a result of the measurement. For example, the density data of the white ink may be obtained from a measuring device that measures the density of the white ink as a result of the measurement.

For example, the image data may be included in a print instruction. The color data of a medium and the density data of white ink that are included in a printing instruction may be sent on an as-needed basis, or may be obtained by the system in advance before the printing instruction is sent. In such cases, the color data of a medium and the density data of white ink may be stored in any desired storage unit.

The controller calculates or determines a concealment ratio of the medium based on the color data of the medium and the density data of the white ink, and calculates an amount of the white ink to be adhered to conceal the medium based on the calculated concealment ratio. For example, when printing is performed on a red polyester fabric, the concealment ratio of the medium is calculated based on the red color data and the density data of the white ink. As described above, in the present embodiment, the amount of the white ink to be adhered to conceal the medium is calculated based on the calculated concealment ratio of the medium. The amount of the white ink to be adhered to conceal the medium may be referred to as, for example, a minimum amount of white ink to be adhered in the following description.

The controller reads a predetermined image parameter in the image data. The controller performs a threshold determination for the read image parameter. The controller adjusts the amount of the white ink to be adhered based on a result of the threshold determination. Due to such a configuration, an appropriate amount of white ink can be applied to a portion of the medium that is affected by its color. Accordingly, the white ink usage can be reduced, and the color tone of the image can be prevented from being changed due to the color of the medium in an unintentional manner.

In the present embodiment, the image parameter is selected from an amount of the color ink to be adhered and the color data measurable by a colorimeter. When one of these elements is used as the image parameter, it is easy to read such data from the image data, and it is easy to set a threshold. Moreover, it is easy to control the amount of white ink to be adhered. When one of these elements is selected to be the image parameter, it becomes easier to set a threshold and perform a threshold determination, and the amount of white ink to be adhered can be controlled more easily. Moreover, the complication of the process of a threshold determination can be prevented. What is selected to be the image parameter is not limited, and any desired image parameter may be selected depending on the usage.

It can be said that the amount of the ink to be adhered is the amount of ink to be discharged obtained by analyzing the input image data. It can be said that adjusting the amount of white ink to be adhered is equivalent to adjusting the amount of the white ink to be discharged. The amount of the ink to be adhered can be determined, for example, as follows. The relation between the color and the amount of color ink to be adhered is calculated by constructing a profile in a stage prior to the discharge. The amount of the ink to be adhered is determined based on the calculated relation and the image data.

The unit of the amount of the ink to be adhered is indicated by, for example, percentage (%), ranging from 0 to 100%. The amount of the ink to be adhered of 0% indicates a state in which even a single droplet of the color ink is not discharged from the nozzle of the discharge device such as an inkjet head. The amount of the ink to be adhered of 100% indicates a state in which the color ink is discharged from all the nozzles of the inkjet head with the maximum amount of discharge per single droplet. For example, the numerical value of the amount of the ink to be adhered is determined as the image data is processed by a raster image processor (RIP). How the amount of white ink to be adhered is converted into numbers is similar to how the amount of color ink to be adhered is converted into numbers.

The color data is data obtainable using a known colorimeter. For example, the color data may be spectral reflectance, spectral transmittance, or various types of color values such as X, Y, Z, L*, a*, b*, Δa*, Δb*, ΔL*, ΔEab*, and YI. Examples of the color data include spectral reflectance, spectral transmittance, brightness, saturation, and density, and it is desired that one of those examples of the color data be selected. These examples of the color data are obtainable using a known colorimeter, and it becomes easier to set a threshold with the obtained color data.

When lightness, saturation, or density is selected as the image parameters, for example, these elements are converted into numbers as follows. For example, when the image parameter indicates the brightness, 0 indicates the brightest condition and 100 indicates the darkest condition, where the brightness is converted into a numerical value ranging between 0 to 100 in several stages. For example, when the image parameter indicates the color saturation, 0 indicates a condition with the lowest saturation and 100 indicates a condition with the highest saturation, where the saturation is converted into a numerical value ranging between 0 to 100 in several stages. For example, when the image parameter indicates the density, 0 indicates a condition with the lowest density and 100 indicates a condition with the highest density, where the density is converted into a numerical value ranging between 0 to 100 in several stages.

As described above, conversion into numbers is carried out with a range from 0 to 100. Due to such a configuration, when a plurality of items are selected as the image parameter, the complication of a threshold determination can be reduced. Regarding the image parameter, it is satisfactory as long as one optimal item is selected depending on the intended use. Each item of the image parameter may have a unique numerical range without the conversion into numbers between 0 and 100. Each item of the threshold used for threshold determination may have a unique value.

How a threshold determination is performed for the image parameter read from the image data and how control is performed based on the result of determination is not limited to any particular method, and any desired method is selectable. Some examples are given below. For example, when the image parameter indicates the amount of color ink to be adhered, the controller determines whether the amount of the color ink to be adhered is equal to or greater than a first threshold. When the amount of the color ink to be adhered is equal to or greater than the first threshold, the white ink is discharged at a predetermined lower limit of the amount of white ink to be adhered. Such a predetermined lower limit of the amount of white ink to be adhered is, for example, a minimum amount of white ink to be adhered to assure a desired level of quality. Due to such a configuration, the ink can be prevented from being dried insufficiently.

For example, when the image parameter indicates color data, the controller determines whether the color data has a value equal to or smaller than a second threshold. When the color data has a value equal to or smaller than the second threshold, the white ink of the calculated amount of the white ink to be adhered is discharged. As described above, the amount of white ink to be adhered is obtained by calculating the concealment ratio of the medium based on the color data of the medium and the density data of the white ink and calculating the amount of the white ink to be adhered to conceal the medium. Due to such a configuration, failure in concealing a medium can be prevented.

As described above, the amount of color ink to be adhered and the above color data are handled separately. Due to such a configuration, the medium can be concealed with reliability, and the ink can be prevented from being dried insufficiently. In such cases, the amount of color ink to be adhered can be prevented from increasing excessively, and the ink can be prevented from being dried insufficiently. When the amount of color ink to be adhered increases excessively, the ink may be dried insufficiently. As the amount of white ink to be adhered is reduced as much as possible, the ink can be prevented from being dried insufficiently. The lower limit of the amount of white ink to be adhered varies depending on, for example, the type of white ink, the type of transfer base material, the type of to-be-transferred material, and the mode of drier. In order to deal with such a situation, it is desired that the conditions be changed in advance, a chart be printed, and the printed chart be examined.

How the value of the color data is set is selected as desired. Due to such selection, it is likely that the color tone of the medium is seen through when the value of the color data is small, and the color tone of the medium has little transparency and is difficult to be seen through when the value of the color data is large. As a result, it becomes easier to set a threshold for the color data and perform a threshold determination.

An area for which the amount of white ink to be adhered is controlled and from which the image parameter is read may be the entire image, but it is desired that these processes be performed in a certain area. In other words, it is desired that the controller read the image parameter in a certain area, perform a threshold determination based on the read image parameter, and control the amount of the white ink to be discharged and adhered. As described above, performing processes in a certain area increases the desired effects. A larger amount of white ink can be applied to a portion to which a large amount of white ink is to be applied to conceal a to-be-transferred material. At portions where it is not necessary to apply a large amount of white ink, the white ink usage can be reduced. Such a certain area is not limited to any particular area, and may be any desired area.

The white ink is used as, for example, a foundation after an image is formed on a medium. Preferably, the controller performs a threshold determination based on the image parameter, and controls the amount of white ink to be adhered that serves as the foundation. As a determination is made based on the image parameter and the amount of white ink to be adhered that serves as the foundation is controlled, an undesired effect of the color tone of a medium can further be reduced.

The position of the foundation after an image is formed on the medium is selected as desired depending on the intended use of a printed material. The layer that is formed by the white ink may be a lower layer than the color ink. Alternatively, the layer that is formed by the white ink may be an upper layer than the color ink. The position of the foundation varies depending on the side of the medium from which the printed material is viewed. For example, when it is assumed that the plane onto which ink is discharged is the front side and the printed material is viewed from the front side, the medium, the layer of white ink, and the layer of color ink are arranged in the order listed. When it is assumed that the plane onto which ink is discharged is the front side and the printed material is viewed from the rear side, the medium, the layer of color ink, and the layer of white ink are arranged in the order listed.

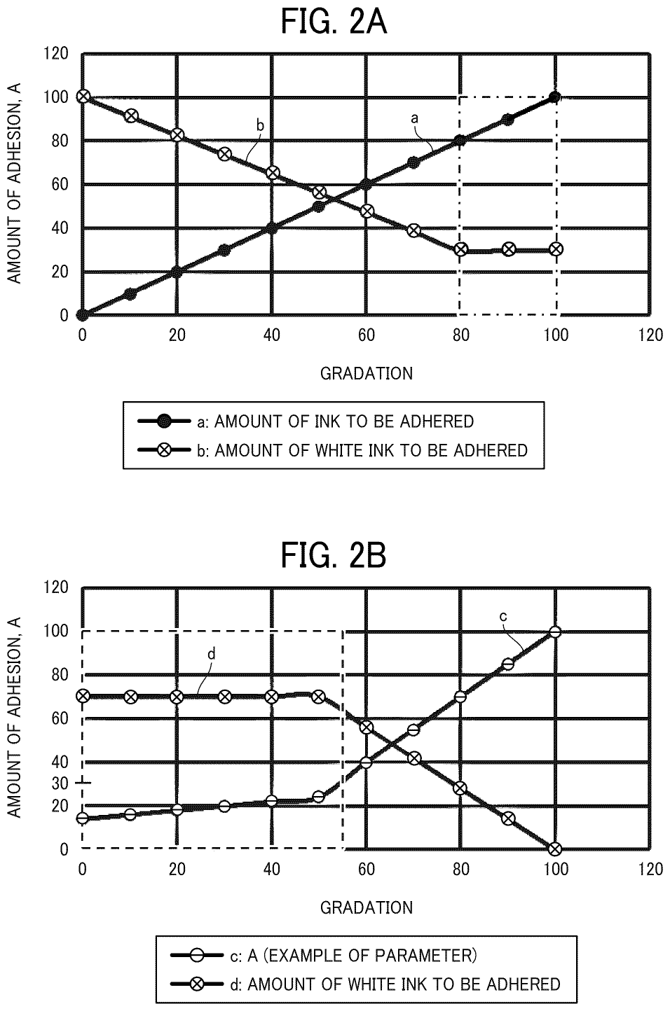

FIG. 2A and FIG. 2B are diagrams each of which illustrates how the amount of white ink to be adhered is adjusted.

FIG. 2A illustrates a cases in which the amount of white ink to be adhered is adjusted based on the amount of color ink to be adhered. FIG. 2B illustrates a cases in which the amount of white ink to be adhered is adjusted based on the color data, which is referred to as a parameter A in the drawing.

In FIG. 2A and FIG. 2B, the horizontal axis indicates the gradation. Although no limitation is indicated thereby, in the present embodiment described with reference to FIG. 2A and FIG. 2B, the measurement unit of the grayscale is indicated by percentage. 0% in gradation indicates that the density of the corresponding color is 0, and 100% in gradation indicates that the maximum density of the corresponding color. Note also that the maximum density of the corresponding color depends on the system. In the horizontal axis of FIG. 2A and FIG. 2B, the range of the gradation from 0 to 100% is divided in stages. The measurement unit of gradation is not limited to %, and may be nondimensional and indicated by values of 0 to 100. In the present embodiment, the gradation depicted in the horizontal axis may be considered to be the amount of color ink to be adhered. Typically, the gradation and the amount of the ink to be adhered correlate with each other.

In FIG. 2A and FIG. 2B, the vertical axis indicates the amount of the ink to be adhered and a parameter A. The unit of the amount of the ink to be adhered is indicated by percentage (%). In the present embodiment, the unit of the parameter A is nondimensional, and the parameter A includes one item of parameter. In the present embodiment described with reference to FIG. 2A and FIG. 2B, the vertical axis is labeled as “amount of adhesion, A.” The amount of adhesion indicates the amount of ink to be adhered. In the present embodiment, the amount of the ink to be adhered and the color data, i.e., the parameter A are depicted on the same scale of 0 to 100. However, no limitation is intended thereby, and the amount of the ink to be adhered and the color data, i.e., the parameter A may be depicted on a different scale. In the present embodiment, none of the amount of the ink to be adhered, the parameter A, and the gradation exceeds 100 such as 100%. However, for the sake of explanatory convenience, the values are depicted up to 120 in FIG. 2A and FIG. 2B.

In FIG. 2A, a plot a indicates the plotted amounts of color ink to be adhered in percentage. In the present embodiment, the amount of color ink to be adhered, which is indicated by percentage (%), is directly proportional to the levels of gradation, which is indicated by, for example, percentage. Typically, numerical values that indicate, for example, the density or brightness of color in several stages are used to indicate the levels of gradation. When the levels of gradation increases, the amount of the color ink to be adhered increases in order to express, for example, the density or brightness of colors. Under these circumstances, in the present embodiment described with reference to FIG. 2A and FIG. 2B, the amount of color ink to be adhered is proportionate to the levels of gradation. Accordingly, in the present embodiment, the gradation depicted in the horizontal axis may be considered to be equivalent to the amount of color ink to be adhered in percentage. In the present embodiment, the amount of color ink to be adhered may be referred to simply as an amount of ink to be adhered.

In FIG. 2A, a plot b indicates the amount of white ink to be adhered in percentage (%) that is adjusted based on the amount of color ink to be adhered. As described above, in the present embodiment, for example, whether the amount of the color ink to be adhered is equal to or greater than a first threshold is determined. When the amount of the color ink to be adhered is equal to or greater than the first threshold, the white ink is discharged at a predetermined lower limit of the amount of white ink to be adhered. In the present embodiment described with reference to FIG. 2A, 80% is selected as the first threshold, and a threshold determination is performed. In the area where the ratio of the amount of color ink to be adhered is 80% or more, a minimum amount of white ink to be adhered to assure a desired level of quality is adopted. In the present embodiment, the area where the ratio of the amount of color ink to be adhered is 80% or more corresponds to an area where the levels of gradation are equal to or greater than 80%, and is indicated by a dot-and-dash line in FIG. 2A.

In the present embodiment, 30% is adopted as a minimum amount of white ink to be adhered to assure a desired level of quality. In the area where the ratio of the amount of color ink to be adhered is 80% or more, the amount of white ink to be adhered is controlled to be 30%. By so doing, the amount of color ink to be adhered can be prevented from decreasing excessively, and for example, the difficulty for adhesive powder to be adhered to an image to be transferred can be reduced. Accordingly, reduction in the robustness against washing or color irregularities on an image can be prevented, and a desired level of quality is achieved.

In an area where the amount of the color ink to be adhered has a value smaller than the first threshold, the amount of the white ink to be adhered can selectively be adjusted. As the plot b indicates, for example, control is performed such that the amount of white ink to be adhered will decrease as the amount of the color ink to be adhered is increased.

In FIG. 2B, the plot c corresponds to the color data. In the present embodiment, the color data is also referred to as a parameter A. The plot c indicates changes in the parameter A with respect to the gradation indicated in the horizontal axis. The color data is described below with reference to, for example, the density. In the present embodiment, the density is low when the value of the color data is smaller, and the density is high when the value of the color data is larger. Accordingly, when the value of the density in the color data is small, it is more likely that the color of the medium affects the image. For this reason, in an area where the value of the color data is small, the amount of white ink to be adhered is increased to conceal the color on the medium.

In FIG. 2B, a plot d indicates the amount of white ink to be adhered in percentage (%) that is adjusted based on the color data. As described above, in the present embodiment, for example, whether the value of the color data is equal to or smaller than the second threshold is determined, and when the color data has a value equal to or smaller than the second threshold, the white ink is discharged in the amount of white ink to be adhered calculated based on the color data of the medium and the density data of the white ink. In the present embodiment described with reference to FIG. 2B, 30 is selected as the second threshold, and a threshold determination is performed. In an area where the color data has a value equal to or smaller than 30, the calculated amount of white ink to be adhered is applied. In the present embodiment, such an area where the color data has a value equal to or smaller than 30 corresponds to an area where the levels of gradation are equal to or lower than about 56%, which is indicated by a broken line in FIG. 2B.

In the present embodiment, for example, the amount of white ink to be adhered is calculated to be 70%. In an area where the color data has a value equal to or smaller than 30, the amount of white ink to be adhered is controlled to be 70%. By so doing, the medium can be concealed with reliability.

In an area where the color data has a value greater than the second threshold, the amount of the white ink to be adhered can selectively be adjusted. As the plot d indicates, for example, in an area where the color data has a large value, the amount of the white ink to be adhered is adjusted to have a smaller value.

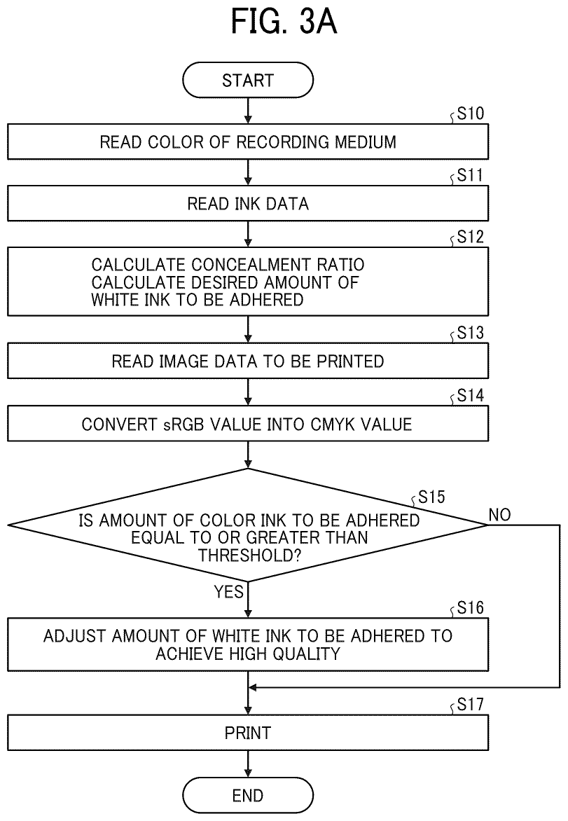

FIG. 3A is a flowchart that corresponds to the present embodiment described with reference to FIG. 2A.

FIG. 3B is a flowchart that corresponds to the present embodiment described with reference to FIG. 2B.

Firstly, description is given below with reference to FIG. 3A. In step S10, the color of a medium is read. In step S11, ink data is read. The ink data includes the density of the white ink, and includes other kinds of information as necessary. Either step S10 or step S11 may be performed first.

The color data of a medium and the ink data are included in, for example, a printing instruction. As the system receives and obtains a printing instruction, the color data and ink data of a medium can be read. Alternatively, for example, the color data and ink data of a medium may be stored in any desired storage unit in advance, and when instructions to perform printing are received, such data may be read from that storage unit. The color data and ink data of a medium may be input by a user, or may be obtained by measurement.

In step S12, the concealment ratio of the medium is calculated based on the color data of a medium and the density data of white ink, and the amount of the white ink to be adhered to conceal the medium is calculated based on the calculated concealment ratio.

In step S13, image data is read. For example, the image data is included in a print instruction. The image data may be stored in any desired storage unit, and the image data may be read from the storage unit. When image data is read, an image parameter is read from the image data.

In step S14, an sRGB value in the image data is converted into a cyan, magenta, yellow, and black (CMYK) value. Due to the conversion into CMYK values, for example, the discharge using the color ink of CMYK can be performed more easily.

In step S15, whether amount of color ink to be adhered is equal to or greater than a threshold is determined. This threshold corresponds to the first threshold described above. When the result of determination is YES, the process proceeds to step S16. When the result of determination is NO, the process proceeds to step S17 with skipping step S16.

In step S16, the amount of white ink to be adhered is adjusted. When the amount of the color ink to be adhered is equal to or greater than a predetermined threshold, the amount of white ink to be adhered with which a preset level of quality is achieved is set. When it is determined to be YES in step S15, an area where the amount of color ink to be adhered has a value equal to or greater than 80 and the level of gradation is greater than, for example, around 80, as depicted in FIG. 2A, is assumed.

In step S17, printing is performed on a medium.

Subsequently, processes are described with reference to FIG. 3B. Redundant descriptions of the same matters as those described above with reference to FIG. 3A may be omitted in the following description. The processes of threshold determination after step S14 are described in the following description.

In step S18, whether the value of the color data is equal to or smaller than a predetermined threshold is determined. Such a threshold corresponds to the second threshold described above. When the result of determination is YES, the process proceeds to step S19. When the result of determination is NO, the process proceeds to step S17 with skipping step S19.

In step S19, the amount of white ink to be adhered is adjusted. When the color data has a value equal to or smaller than a predetermined threshold, the amount of white ink to be adhered calculated in step S12 is set. When it is determined to be YES in step S18, an area where the parameter A indicates a value equal to or smaller than 30 and the levels of gradation are equal to or lower than, for example, about 56%, as depicted in FIG. 2B, is assumed.

In step S17, printing is performed on a medium.

With the printing system, the printer, and the printing method according to the present embodiment, while reducing the white ink usage, the color tone of the medium can be prevented from being seen through, and the color tone of the image can be prevented from being changed due to the color of the medium in an unintentional manner.

Supplemental description is given below of how the amount of the white ink to be adhered is adjusted, which indicated by the plot b or the plot d. Plots b and d indicate the amount of white ink to be adhered in percentage (%) that is adjusted based on the color data or the amount of color ink to be adhered. In the present embodiment, the first to fourth conditions are used to adjust the amount of white ink to be adhered.

### First Condition

Minimum amount of white ink to be adhered to assure desired level of quality: 30%

### Second Condition

Amount of color ink to be adhered with which ink is dried insufficiently: 80% or more

### Third Condition

Desired amount of white ink to be adhered calculated based on concealment ratio of medium: 70%

### Fourth Condition

Condition of color data or parameter A with which color tone of medium is seen through: Parameter A indicates value equal to or greater than 30

The first condition defines a minimum amount of white ink to be adhered to assure a desired level of quality. When a small amount of ink is adhered, for example, it becomes difficult for the powder to be adhered to an image to be transferred. Accordingly, reduction in the robustness against washing or color irregularities on an image can be prevented are concerned. Accordingly, as in the first condition, a lower limit is set for the amount of white ink to be adhered. The quality that relates to, for example, color irregularities varies depending on the combination of ink and a medium. For this reason, it is desired that the amount of the ink to be adhered be changed for every type of ink or medium. The first condition is to be set in view of the results of printing a chart and examining the printed chart.

The second condition defines the amount of color ink to be adhered with which the ink is dried insufficiently. For example, when the levels of gradation or the amount of the color ink to be adhered is large, the amount of the color ink on the medium increases, and thus drying operation has to be done to a sufficient degree. In view of these circumstances, in an area where the amount of the color ink to be adhered is large, the amount of the white ink to be adhered to conceal the medium is reduced. The amount of ink to be adhered with which the ink is dried insufficiently varies depending on, for example, types of drier or ink. For this reason, it is desired that the amount of the ink to be adhered be changed for every type of ink or depending on the length of time for which a drier is used for drying or the drying power. The second condition is to be set in view of the results of printing a chart and examining the printed chart.

The third condition defines a desired amount of white ink to be adhered calculated based on the concealment ratio of a medium. The third condition is determined in, for example, the process in step S12 of FIG. 3A or FIG. 3B. The concealment ratio of the medium is calculated based on the color data of a medium and the density data of white ink, and the amount of the white ink to be adhered to conceal the medium is calculated based on the calculated concealment ratio.

The fourth condition defines the condition of the color data with which the color tone of the medium is seen through. For example, when the color has a low brightness and the color data has a large value, the color tone of the medium has little transparency and is difficult to be seen through. By contrast, when the brightness is high and the color data has a small value, the color tone of the medium has transparency and is easy to be seen through. The conditions for the color tone to be seen through vary depending on, for example, the type of color data, the color of the medium, and the type of ink. For this reason, the fourth condition is be set in view of the results of printing a chart for each element and examining the printed chart. In addition to the brightness, for example, when the density is high (a value of the color data is large), when the level of density is high and the color data has a large value, the color tone of the medium has little transparency and is difficult to be seen through. By contrast, when the level of density is low and the color data has a small value, it is likely that the color tone of the medium is seen through.

More specifically, in FIG. 2B, the color data, i.e., the parameter A, is converted into numbers as follows. In FIG. 2B, the setting of values of the color data, which ranges from 0 to 100, is calculated based on the hue saturation value (HSV) or the red, green, and blue (RGB) value, which is included in, for example, the image data.

In a similar manner to FIG. 2B or step S18 in FIG. 3B as described above, a threshold determination is performed, and whether the color data satisfies the fourth condition is determined. In other words, whether the color data has a value equal to or smaller than 30 is determined. In an area where the levels of gradation are equal to or lower than 56, which is encompassed by a rectangle of a broken line, the color data, which is indicated by the plot c, has a value equal to or smaller than 30. For this reason, it is assumed that the color tone of the medium is seen through. Accordingly, the third condition, i.e., a minimum amount of white ink to be adhered (70%) to assure a desired level of quality, which calculated based on concealment ratio of medium, is applied to an area where the levels of gradation are equal to or lower than 56. Accordingly, the amount of white ink to be adhered, which is indicated by the plot d, is adjusted to 70% in an area where the levels of gradation are equal to or lower than 56, which is encompassed by a rectangle of a broken line. Due to such a configuration, the color tone of the medium can be prevented from being seen through.

In a similar manner to FIG. 2A or step S15 in FIG. 3A, a threshold determination is performed. An area where the ratio of the amount of color ink to be adhered is about 80% or more corresponds to the second condition, and the amount of ink to be adhered is large in such an area. For this reason, it is desired that the drying performance be taken into consideration. In view of such circumstances, the first condition is applied to an area where the ratio of the amount of color ink to be adhered is about 80% or more. Accordingly, the amount of white ink to be adhered, which is indicated by the plot b, is adjusted to 30% in an area where the levels of gradation are equal to or higher than around 80, which is encompassed by a rectangle of a dot-and-dash line.

Typically, in the DTF printing on a on a transfer base material such as a film, there is a demand for lowering the drying temperature of a drier such as a heater for a printing device. As the drying temperature is lower, the wettability of the printing device increases, and the color reproduction is enhanced. Moreover, the discharge performance of the liquid discharge head is stabilized. However, when the drying temperature is low, the color ink may insufficiently be dried in an area where the amount of ink to be adhered is large. In such cases, abnormality such as undesired ink flow, cissing, and feathering may take place. When the amount of ink to be adhered is simply reduced, it is likely that the color tone of the to-be-transferred material is seen through.

In the present embodiment, in an area where the amount of the color ink to be adhered is large and it likely that the ink cannot sufficiently be dried, the amount of white ink to be adhered is reduced while securing a minimum amount of white ink to be adhered. Due to such configurations as described above, the color tone of the medium is prevented from being seen through, and the amount of white ink to be adhered is reduced. As a result, the ink is prevented from being dried insufficiently, and the ink can be prevented from flowing and the ink can be prevented from being dried insufficiently.

As described above, according to the present embodiment, the amount of white ink to be adhered is adjusted. By so doing, the white ink is not excessively used, and the color tone of the image can be prevented from being changed in an unintentional manner due to the color of the medium. Even when white ink is used in order to prevent the color tone of the medium from being seen through, for example, the drying performance is increased, and a desired level of quality is achieved.

As described above, in the present embodiment, it is desired that a threshold determination for the image parameter and adjustment for the amount of the white ink to be adhered be performed in a certain area. As the amount of the white ink to be adhered in a certain area is adjusted, a minimum amount of white ink to prevent the color tone of the medium from being seen through in a certain area is applied, and the white ink usage in a certain area can appropriately be adjusted. Accordingly, the white ink usage can be reduced, and favorable results can be obtained from the viewpoint of reducing the cost. As the amount of the white ink to be adhered in a certain area is adjusted, an undesired ink flow can be handled easily.

### Second Embodiment

In the embodiment described above, typically, a threshold determination for the image parameter is performed using either one of the amount of the color ink to be adhered or the color data. However, no limitation is intended thereby, and both the amount of the color ink to be adhered and the color data may be used as the image parameter. A threshold determination may be performed for the image parameter using both the amount of the color ink to be adhered and the color data.

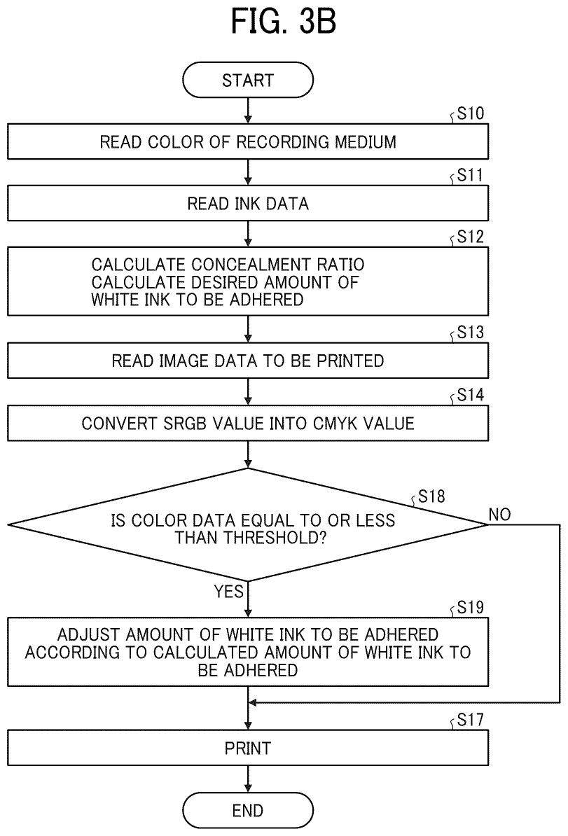

FIG. 4 is a diagram illustrating how the amount of white ink to be adhered is adjusted.

FIG. 4 is a plot similar to FIG. 2A or FIG. 2B, with the same horizontal and vertical axes as in FIG. 2A and FIG. 2B. The plots a and c in FIG. 4 are equivalent to the plots a and c in FIG. 2A and FIG. 2B. The plot a corresponds to the amount of color ink adhesion, and the plot c corresponds to the color data. A plot e corresponds to the amount of white ink to be adhered.

In a similar manner to FIG. 2A, whether the amount of the color ink to be adhered is equal to or greater than the first threshold such as 80 is determined. When the amount of the color ink to be adhered is equal to or greater than the first threshold, preferably, a minimum amount of white ink to be adhered to assure a desired level of quality, which is, for example, 30%, is adopted. In an area where the ratio of the amount of color ink to be adhered is about 80% or more and the levels of gradation are equal to or greater than around 80%, which is encompassed by a rectangle of a dot-and-dash line, the color data, which is indicated by the plot c, has a value that exceeds 30. Accordingly, it is assumed that such an area is not affected by the color of the to-be-transferred material without applying the third condition.

In a similar manner to FIG. 2B, whether the color data has a value equal to or smaller than the second threshold such as 30 is determined. When the color data has a value equal to or smaller than the second threshold, preferably, a calculated amount of white ink to be adhered to achieve concealment, which is, for example, 70%, is adopted.

In the present embodiment, both a threshold determination for the amount of color ink to be adhered and a threshold determination for the color data are performed. Due to such a configuration, as indicated by the plot e in FIG. 4, the amount of white ink to be adhered of 30% is applied to an area where the amount of the color ink to be adhered is equal to or greater than the first threshold and the levels of gradation are equal to or greater than 80%, which is indicated by a rectangle of a dot-and-dash line, and the amount of white ink to be adhered of 70% is applied to an area where the color data has a value equal to or smaller than the second threshold and the levels of gradation are equal to or smaller than 56%, which is indicated by a rectangle of a broken line.

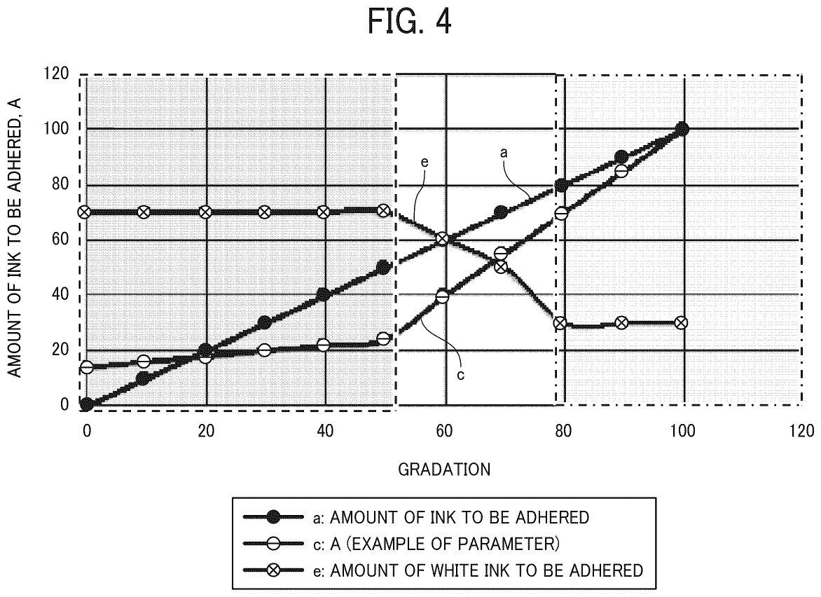

FIG. 5 is another flowchart of the processes executed by the printing system 10 when a threshold determination is made for color data and the amount of color ink to be adhered.

Among FIG. 3A, FIG. 3B, and FIG. 5, identical or similar reference signs denote identical or similar elements, and overlapping description may be simplified or omitted as appropriate. In the present embodiment described with reference to FIG. 5, a threshold determination for the amount of color ink to be adhered (step S15) and a threshold determination for the color data (step S18) are executed in the same series of processes. As a result, as indicated by the plot e in FIG. 4, the amount of white ink to be adhered is adjusted.

As described above, a threshold determination may be performed for the image parameter using both the amount of the color ink to be adhered and the color data.

Some supplementary explanation is given below about the processes described with reference to FIG. 5. In the above processes described with reference to FIG. 5, the determination in step S18 and the determination in step S15 are performed. More specifically, whether the color data has a value equal to or smaller than a threshold is determined first in step S18, and the determination in step S15 as to whether the amount of color ink to be adhered is equal to or greater than a threshold is performed later. In the present embodiment described with reference to FIG. 4, YES is expected in either one of the processes in step S18 and step S15. However, no limitation is intended thereby, and it is determined to be YES as a result of both processes in step S18 and step S15. In such cases, one of the determination in step S15 as to whether that the amount of color ink to be adhered is equal to or greater than a threshold and the determination in step S18 as to whether the color data has a value equal to or smaller than a threshold is prioritized by performing to-be-prioritized one of the determinations first.

In the processes described with reference to FIG. 5, the determination in step S15 as to whether the amount of color ink to be adhered is equal to or greater than a threshold is performed later. For this reason, the process in step S16 to be performed when it is determined that the amount of color ink to be adhered is equal to or greater than a threshold (YES in step S15) is prioritized. For example, it is determined that the color data has a value equal to or smaller than a threshold (YES in step S18), and in step S19, the amount of white ink to be adhered is adjusted. Then, it is determined that the amount of color ink to be adhered is equal to or greater than a threshold (YES in step S15), and in step S16, the amount of white ink to be adhered is adjusted. In such cases, the adjustment in step S16 is reflected. Any desired one of the determinations may be performed before or after the other determinations in view of, for example, the usage of a printed material.

In the present embodiment described with reference to FIG. 4, the amount of white ink to be adhered, which is indicated by a plot e, is changed continuously in an area where the levels of gradation are greater than around 56% and an area where the levels of gradation are smaller than around 80%. In other words, the amount of white ink to be adhered, which is indicated by the plot e, is 70% in an area where the levels of gradation are around 50%, and the amount of white ink to be adhered, which is indicated by the plot e, is made close to 30% as the levels of gradation increase to around 80%. In an area where the color data has a value greater than 30 and the color data has a value close to 30, an undesired effect of the color tone of a medium is small. When the white ink is discharged with an amount close to a desired amount of white ink to be adhered calculated based on concealment ratio of medium, which is 70% as in the third condition, an undesired effect of the color tone of a medium can be reduced with greater reliability.

When the color data is greater than the second threshold, i.e., 30 as defined in the fourth condition of the present embodiment, and the amount of the color ink to be adhered is smaller than the first threshold, i.e., 80 as defined in the second condition of the present embodiment, it is desired that the amount of white ink to be adhered be reduced gradually from the amount of white ink to be adhered when the color data has a value equal to or smaller than the second threshold to the amount of white ink to be adhered when the amount of the color ink to be adhered is equal to or greater than the first threshold. In the present embodiment, the amount of white ink to be adhered is gradually reduced from 70% as defined in the third condition to 30% as defined in the first condition.

### Third Embodiment

When the amount of the ink to be adhered greatly varies between adjacent areas, the ink tends to flow into an area where the amount of the ink to be adhered is small. Such flown ink affects the image quality. In the present embodiment, a pair of neighboring areas are compared with each other, and the amount of the ink to be adhered is adjusted such that the difference in the total amount of the ink to be adhered between a pair of neighboring areas will be small. This prevents the ink from flowing.

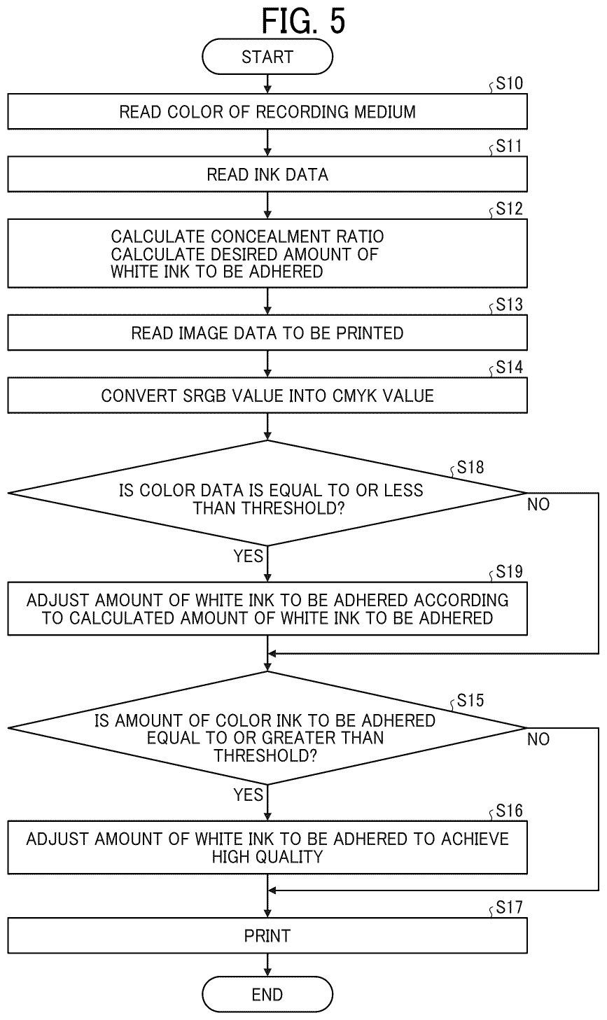

FIG. 6A and FIG. 6B are schematic diagrams illustrating an undesired ink flow.

FIG. 6A is a diagram illustrating a situation before ink starts flowing.

FIG. 6B is a diagram illustrating a situation after the ink has started flowing.

The ink tends to flow from an area where the amount of the ink to be adhered is as large as 100% (on the left side of FIG. 6B) to an area where the amount of the ink to be adhered is as small as 30% (on the right side of FIG. 6B).

In the present embodiment, the difference in the total amount of the ink to be adhered between a pair of neighboring areas is reduced. This prevents the ink from flowing. In order to reduce the difference in the total amount of the ink to be adhered between a pair of neighboring areas, for example, the amount of the ink to be adhered at the boundary between a pair of neighboring areas may be adjusted to appear in gradation. Alternatively, invisible ink may be applied. When invisible ink is to be applied, it is desired that the amount of the adhesion of the invisible ink be adjusted.

In the present embodiment, it is assumed that the amount of white ink to be adhered in the corresponding area is constant. Accordingly, it is considered that the amount of the ink to be adhered as above is equivalent to the amount of color ink to be adhered. For example, the amount of adhesion of the invisible ink is increased in an area where the amount of ink to be adhered is small.

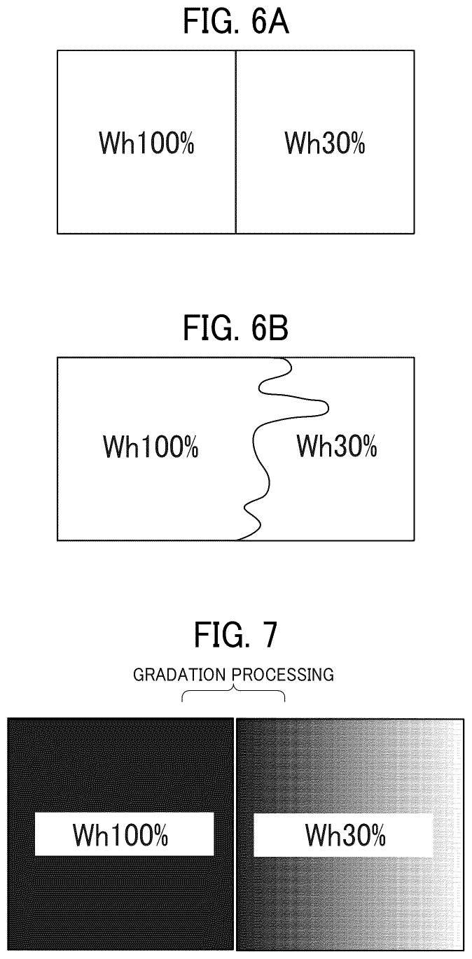

FIG. 7 is a schematic diagram illustrating gradation processing.

For example, in an area where the amount of the ink to be adhered is 30% (on the right side of FIG. 7), the amount of the ink to be adhered is gradually increased as it gets close to an adjacent area on the boundary of the neighboring area (on the left side of FIG. 7). Due to such a configuration as described above, the difference in the amount of the ink to be adhered between a pair of neighboring areas can be reduced. Alternatively, in an area where the amount of the ink to be adhered is 100% (on the left side of FIG. 7), the amount of the ink to be adhered may gradually be reduced as it gets close to an adjacent area on the boundary of the neighboring area (on the right side of FIG. 7).

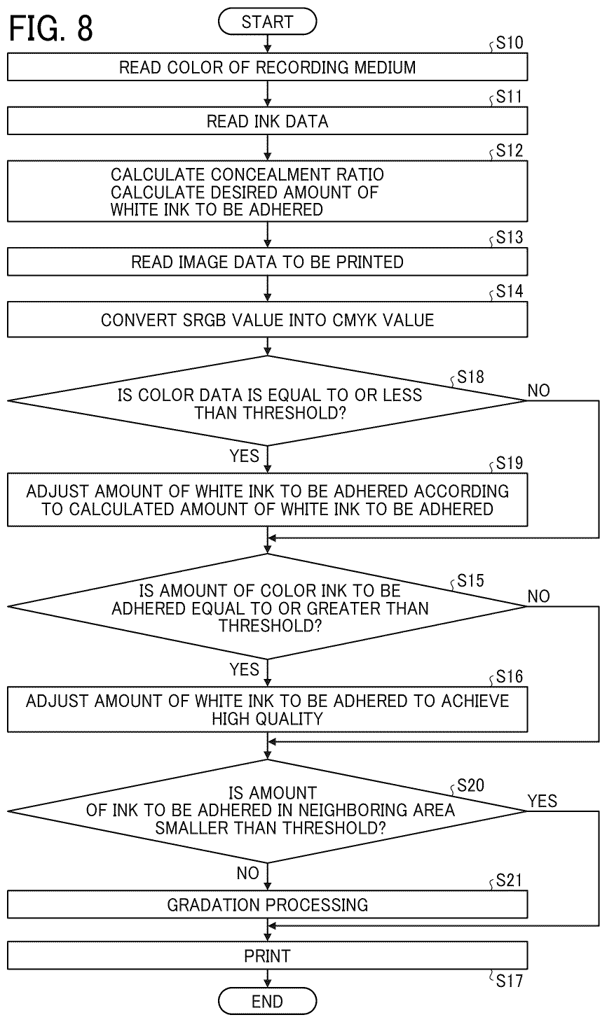

FIG. 8 is another flowchart of the processes executed by the printing system 10.

Redundant descriptions of the same matters as those described above with reference to FIG. 3A, FIG. 3B, and FIG. 5 may be omitted in the following description. In a similar manner to the processes described with reference to FIG. 5, in the present embodiment described with reference to 8, a threshold determination for the amount of color ink to be adhered (step S15) and a threshold determination for the color data (step S18) are executed in the same series of processes. However, no limitation is intended thereby. In a similar manner to the description with reference to FIG. 3A and FIG. 3B, any one of a threshold determination for the amount of color ink to be adhered (step S15) or a threshold determination for the color data (step S18) may be performed.

In step S20, whether amount of ink to be adhered at neighboring area is smaller than a threshold is determined. In other words, in the present embodiment, after the amount of white ink to be adhered is adjusted, the total amount of the ink to be adhered in a certain area is calculated, and the total amount of ink to be adhered in a certain area is compared with the total amount of ink to be adhered in another neighboring certain area. When the amount of ink to be adhered at a neighboring area is equal to or smaller than a threshold, the process in step S21 is skipped and printing in step S17 is performed. When the amount of ink to be adhered at a neighboring area is equal to or greater than a threshold, the process in step S21 is performed on such a neighboring area at that position.

In step S21, gradation processing is performed on a pair of adjacent areas. In the gradation processing, the amount of the color ink to be adhered in one of a pair of adjacent areas or both of those adjacent areas is adjusted.

In step S17, printing is performed on a medium. As described above, with the printing system according to the present embodiment, the amount of the ink to be adhered is adjusted such that the difference in the amount of the ink to be adhered between a pair of neighboring areas will not be too large. By so doing, in addition to the effects achieved in the above-described embodiment, the deterioration of image quality due to the flown ink can be prevented.

In the processes described above with reference to FIG. 8, the gradation processing is described. Alternatively, adjustment may be performed using, for example, invisible ink. The amount of the invisible ink to be adhered is adjusted such that the difference in the amount of the ink to be adhered between a pair of neighboring areas will be equal to or smaller than a predetermined threshold. By so doing, the ink can be prevented from flowing.

In the present embodiment, the controller calculates the total amount of the ink to be adhered, which indicates the sum total of the amounts of all the kinds of ink to be adhered, in a certain area. When the difference in the total amount of the ink to be adhered between a pair of neighboring areas is equal to or greater than a predetermined threshold, the amount of the color ink to be adhered is adjusted such that the difference in the total amount of the ink to be adhered between a pair of neighboring areas will be smaller than a predetermined threshold, and gradation processing is performed.

Alternatively, in the present embodiment, the discharge device discharges invisible ink, and the controller calculates the total amount of the ink to be adhered, which indicates the sum total of the amounts of all the kinds of ink to be adhered, in a certain area. When the difference in the total amount of the ink to be adhered between a pair of neighboring areas is equal to or greater than a predetermined threshold, the amount of the invisible ink to be adhered is adjusted such that the difference in the total amount of the ink to be adhered between a pair of neighboring areas will be smaller than a predetermined threshold.

### Fourth Embodiment

In the present embodiment, ink is discharged onto a transfer base material. Redundant descriptions of the same matters as those described above may be omitted in the following description.

A printing system according to the present embodiment includes a discharge device to discharge color ink and white ink to a transfer base material and a controller to control the discharge device. The color ink and the white ink discharged to the transfer base material are transferred to a to-be-transferred material, and the printing system obtains image data, color data of the to-be-transferred material, and density data of the white ink. The controller calculates a concealment ratio of the to-be-transferred material based on the color data of the to-be-transferred material and the density data of the white ink, and calculates an amount of the white ink to be adhered to conceal the to-be-transferred material based on the calculated concealment ratio. The controller reads an image parameter given below in the image data, and performs a threshold determination for the read image parameter, and adjusts the amount of the white ink to be adhered based on a result of the threshold determination.

### Image Parameter

The image parameter is at least one image parameter selected from an amount of the color ink to be adhered and the color data measurable by a colorimeter.

The printer according to the present embodiment includes a discharge device to discharge color ink and white ink to a transfer base material and a controller to control the discharge device. The color ink and the white ink discharged to the transfer base material are transferred to a to-be-transferred material, and the printer obtains image data, color data of the to-be-transferred material, and density data of the white ink. The controller calculates a concealment ratio of the to-be-transferred material based on the color data of the to-be-transferred material and the density data of the white ink, and calculates an amount of the white ink to be adhered to conceal the to-be-transferred material based on the calculated concealment ratio. The controller reads an image parameter given below in the image data, and performs a threshold determination for the read image parameter, and adjusts the amount of the white ink to be adhered based on a result of the threshold determination.

### Image Parameter

The image parameter is at least one image parameter selected from an amount of the color ink to be adhered and the color data measurable by a colorimeter.

The printing method according to the present embodiment includes discharging, using a printer, color ink and white ink to a transfer base material, and controlling discharge of the color ink and the white ink. The color ink and the white ink discharged to the transfer base material are transferred to a to-be-transferred material. In the printing method, image data, color data of the to-be-transferred material, and density data of the white ink are obtained. The controlling includes calculating a concealment ratio of the to-be-transferred material based on the color data of the to-be-transferred material and the density data of the white ink, and calculating an amount of the white ink to be adhered to conceal the to-be-transferred material based on the calculated concealment ratio. The controlling further includes reading an image parameter given below in the image data, performing a threshold determination for the read image parameter, and adjusting the amount of the white ink to be adhered based on a result of the threshold determination.

### Image Parameter

The image parameter is at least one image parameter selected from an amount of the color ink to be adhered and the color data measurable by a colorimeter.

In the present embodiment, a concealment ratio of the to-be-transferred material is calculated based on the color data of the to-be-transferred material and the density data of the white ink, and an amount of the white ink to be adhered to conceal the to-be-transferred material is calculated based on the calculated concealment ratio. An image parameter is read from the image data, and whether the read image parameter is equal to or less than a predetermined threshold is determined. The amount of the white ink to be adhered is adjusted based on the result of the determination.

For example, when the image parameter is equal to or less than a predetermined threshold, the white ink is discharged with the calculated amount of white ink to be adhered. Due to such a configuration, a required amount of white ink can be applied to a portion of the to-be-transferred material that is affected by its color. As a result, the white ink usage is reduced, and the color tone of transferred images can be unified regardless of the types of to-be-transferred materials.

The printing system according to the present embodiment is applicable to the DTF printing.

The ink that is discharged to the transfer base material is transferred to a to-be-transferred material. In other words, the image that is formed on the transfer base material is transferred to a to-be-transferred material. Any desired transfer base material may be selected, and for example, a film is used where appropriate. Any desired to-be-transferred material may be selected, and for example, a cloth such as a T-shirt is used where appropriate. Such a cloth may be, for example, a polyester fabric. For example, a to-be-transferred material may be regarded or referred to as a to-be-printed material.

A method of transferring the image that is formed on a transfer base material to a to-be-transferred material is not limited to any particular method, and any desired method may be adopted. For example, adhesive powder is applied to the image that is formed on a transfer base material, and a transfer base material is overlaid with a to-be-transferred material. As necessary, heating or pressurization is performed for transfer.

A printing system according to the present embodiment includes a discharge device to discharge color ink and white ink to a transfer base material and a controller to control the discharge device. In the printing system, the discharge device and the controller may be separated from each other, or the discharge device and the controller may be arranged in the same apparatus.

The system configuration in the present embodiment is similar to that of the first embodiment described above. Accordingly, differences in configuration from the first embodiment as described above are described below. In the first embodiment described above, ink is discharged onto a medium. By contrast, in the present embodiment, the ink is discharged onto a to-be-transferred material. In the present embodiment, a concealment ratio of the to-be-transferred material is calculated based on the obtained color data of the to-be-transferred material.

The printing system according to the present embodiment obtains image data, the color data of the to-be-transferred material, and the density data of the white ink. The printing system according to the present embodiment may obtain the above data from a device other than the information processing device 1. For example, the color data of the to-be-transferred material may be obtained from a measuring device that measures the color of the to-be-transferred material as a result of the measurement.

For example, the image data may be included in a print instruction. The color data of a to-be-transferred material and the density data of white ink that are included in a printing instruction may be sent on an as-needed basis, or may be obtained by the system in advance before the printing instruction is sent.

The controller calculates a concealment ratio of the to-be-transferred material based on the color data of the to-be-transferred material and the density data of the white ink, and calculates an amount of the white ink to be adhered to conceal the to-be-transferred material based on the calculated concealment ratio. For example, when an image is transferred onto a red polyester fabric, the concealment ratio of the to-be-transferred material is calculated based on the red color datal and the density data of the white ink. As described above, in the present embodiment, the amount of the white ink to be adhered to conceal the to-be-transferred material is calculated based on the calculated concealment ratio of the to-be-transferred material. The amount of the white ink to be adhered to conceal the to-be-transferred material may be referred to as, for example, a minimum amount of white ink to be adhered in the following description.

The controller reads a predetermined image parameter in the image data. The controller performs a threshold determination for the read image parameter. The controller adjusts the amount of the white ink to be adhered based on a result of the threshold determination. Due to such a configuration, a required amount of white ink can be applied to a portion of the to-be-transferred material that is affected by its color. Accordingly, the white ink usage can be reduced, and the color tone of the image can be prevented from being changed due to the color of the to-be-transferred material in an unintentional manner.

As the image parameter according to the present embodiment can be made similar to that of the first embodiment described above, its detailed description is omitted.

How a threshold determination is performed for the image parameter read from the image data can be made similar to that of the first embodiment described above. For example, the controller determines whether the amount of the color ink to be adhered is equal to or greater than a first threshold. When the amount of the color ink to be adhered is equal to or greater than the first threshold, the white ink is discharged at a predetermined lower limit of the amount of white ink to be adhered. Such a predetermined lower limit of the amount of white ink to be adhered is, for example, a minimum amount of white ink to be adhered to assure a desired level of quality. Due to such a configuration as described above, the ink can be prevented from being dried insufficiently.

For example, the controller determines whether the color data is equal to or smaller than a second threshold. When the color data has a value equal to or smaller than the second threshold, the white ink of the calculated amount of the white ink to be adhered is discharged. As described above, the amount of white ink to be adhered is obtained by calculating the concealment ratio of the to-be-transferred material based on the color data of the to-be-transferred material and the density data of the white ink and calculating the amount of the white ink to be adhered to conceal the to-be-transferred material. Due to such a configuration, failure in concealing a to-be-transferred material can be prevented.

As described above, the amount of color ink to be adhered and the above color data are handled separately. By so doing, the to-be-transferred material can be concealed with reliability, and the ink can be prevented from being dried insufficiently.

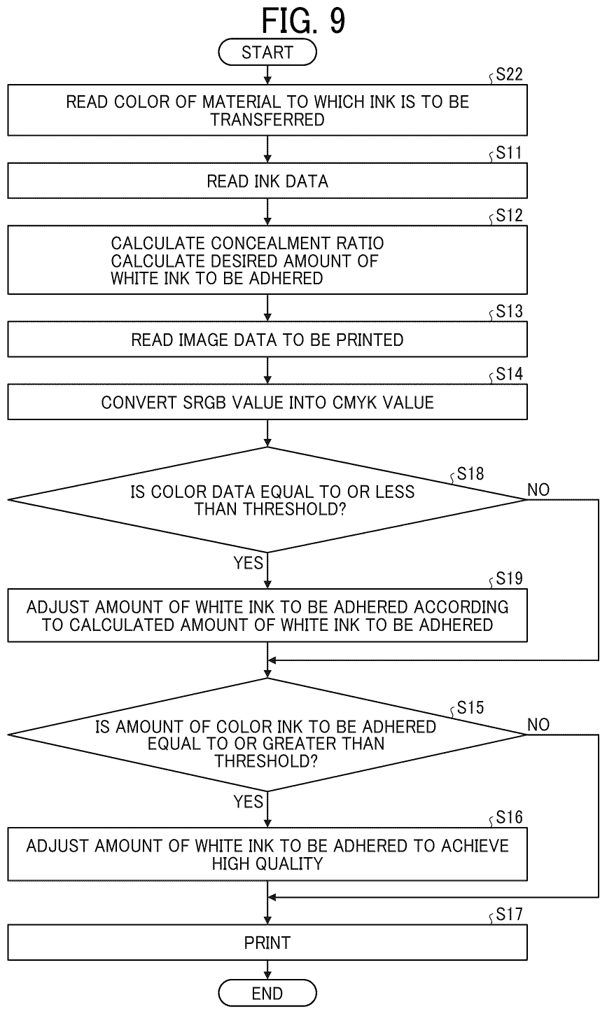

FIG. 9 is another flowchart of the processes executed by the printing system 10.

Redundant descriptions of the same matters as those described above with reference to FIG. 3A, FIG. 3B, and FIG. 5 may be omitted in the following description. In a similar manner to the processes described with reference to FIG. 5, in the present embodiment described with reference to FIG. 9, a threshold determination for the amount of color ink to be adhered (step S15) and a threshold determination for the color data (step S18) are executed in the same series of processes. However, no limitation is intended thereby. In a similar manner to the description with reference to FIG. 3A and FIG. 3B, any one of a threshold determination for the amount of color ink to be adhered (step S15) or a threshold determination for the color data (step S18) may be performed.

In step S22, the color of a to-be-transferred material is read. The color data and ink data of a to-be-transferred material are included in, for example, a print instruction from a user, and the color data and ink data of a to-be-transferred material can be read as the system receives and obtains a printing instruction. Alternatively, for example, the color data and ink data of a to-be-transferred material are stored in any desired storage unit in advance, and are read from the storage unit when instructions to perform printing are received. The color data and ink data of a to-be-transferred material may be input by a user, or may be obtained by measurement.

In step S12, the concealment ratio of the to-be-transferred material is calculated based on the color data of the to-be-transferred material and the density data of the white ink, and the amount of the white ink to be adhered to conceal the to-be-transferred material is calculated based on the calculated concealment ratio. The calculation in the present embodiment may be referred to as determination in the following description.

In a similar manner to FIG. 3A, FIG. 3B, and FIG. 5, a threshold determination is performed in steps S15 and S18, and the amount of the white ink to be adhered is adjusted based on a result of the threshold determination. As described above, with the printing system according to the present embodiment, the color tone of the to-be-transferred material can be prevented from being seen through while reducing the white ink usage, and the color tone of the image can be prevented from being changed due to the color of the to-be-transferred material in an unintentional manner. For example, cases in which the lightness is used as the image parameter are described below. When the color has a brightness lower than a certain value, it is less likely that the color tone of the to-be-transferred material is seen through. Accordingly, the color tone of the to-be-transferred material can be prevented from being seen through without increasing the amount of white ink to be adhered. By contrast, when the color has a brightness higher than a certain value, it is likely that the color tone of the to-be-transferred material is seen through. For this reason, adjustment is made such that the ink is discharged with the calculated lower limit of the amount of white ink to be adhered. According to such a configuration, the color tone of the to-be-transferred material can be prevented from being seen through, and the color tone of the image can be prevented from being changed due to the color of the to-be-transferred material in an unintentional manner. Elements other than the brightness are described below. For example, when the density is higher than a certain value, it is less likely that the color tone of the to-be-transferred material is seen through. Moreover, when the density is lower than a certain value, it is likely that the color tone of the to-be-transferred material is seen through.

Also in the present embodiment, the amount of the white ink to be adhered is adjusted in a similar manner to the above description with reference to, for example, FIG. 2A and FIG. 2B. In the above description of the first embodiment, the medium is read as a to-be-transferred material where appropriate. For example, the third condition is read as a desired amount of white ink to be adhered calculated based on the concealment ratio of a to-be-transferred material. For example, the fourth condition is replaced with the image parameter condition under which the color of the transfer material is transparent.

In view of the first condition according to the present embodiment, the quality that relates to, for example, color irregularities varies depending on the combination of ink and a to-be-transferred material. For this reason, it is desired that the amount of the ink to be adhered be changed for every type of ink or to-be-transferred material. The first condition is to be set in view of the results of printing a chart and examining the printed chart.

In a similar manner to the above description of the first embodiment, also in the present embodiment, the amount of the white ink to be adhered is adjusted in a similar manner to the above description with reference to, for example, FIG. 2A, FIG. 2B, and FIG. 5 (see, for example, the plot b, the plot d, and the plot e).

For example, as in step S18 of FIG. 9, a threshold determination is made for the color data. In the present embodiment, whether the color data satisfies the fourth condition is determined. In other words, whether the color data has a value equal to or smaller than 30 is determined. In an area where the levels of gradation are equal to or lower than around 56, which is encompassed by a rectangle of a broken line, the color data, which is indicated by the plot c, has a value equal to or smaller than 30. For this reason, it is assumed that the color tone of the to-be-transferred material is likely to be seen through. In order to handle such a situation, in an area where the levels of gradation are equal to or lower than around 56, a minimum desired amount of white ink to be adhered, which is 70% calculated based on the third condition, i.e., a concealment ratio, to assure a desired level of quality is adopted. Accordingly, the amount of white ink to be adhered, which is indicated by the plot c, is adjusted to 70% in an area where the levels of gradation are equal to or lower than around 56, which is encompassed by a rectangle of a broken line. Due to such a configuration, the color tone of the to-be-transferred material can be prevented from being seen through.

An area where the ratio of the amount of color ink to be adhered is equal to or greater than about 80% is an area where the levels of gradation are equal to or greater than around 80%, which is encompassed by a rectangle of a dot-and-dash line. When a threshold determination is made for the color data in such an area, the color data, which is indicated by the plot c, has a value that exceeds 30. Accordingly, it is assumed that such an area is not affected by the color of the to-be-transferred material without applying the third condition.

By contrast, an area where the ratio of the amount of color ink to be adhered is about 80% or more is the area that corresponds to the second condition, and the amount of ink to be adhered is large in such an area. In order to deal with such a situation, it is desired that the drying performance be taken into consideration. For example, as in step S15 of FIG. 9, a threshold determination is made for the amount of color ink to be adhered, and the first condition is applied to an area where the ratio of the amount of color ink to be adhered is about 80% or more. Accordingly, the amount of white ink to be adhered, which is indicated by the plot b and plot e, an area where the levels of gradation are equal to or greater than around 80, which is encompassed by a rectangle of a dot-and-dash line, is adjusted to 30%.

Typically, in the DTF printing on a on a transfer base material such as a film, there is a demand for lowering the drying temperature of a drier such as a heater for a printing device. As the drying temperature is lower, the wettability of the printing device increases, and the color reproduction is enhanced. Moreover, the discharge performance of the liquid discharge head is stabilized. However, when the drying temperature is low, the color ink may insufficiently be dried in an area where the amount of ink to be adhered is large. In such cases, abnormality such as undesired ink flow, cissing, and feathering may take place. When the amount of ink to be adhered is simply reduced, it is likely that the color tone of the to-be-transferred material is seen through.

In the present embodiment, in an area where the amount of the color ink to be adhered is too large to dry the ink sufficiently, the amount of white ink to be adhered is reduced while securing a minimum amount of white ink to be adhered. Due to such a configuration, the color tone of the to-be-transferred material is prevented from being seen through, and the amount of white ink to be adhered is reduced. As a result, the ink is prevented from being dried insufficiently, and the ink can be prevented from flowing and the ink can be prevented from being dried insufficiently.

As the amount of white ink to be adhered is adjusted as described above, the color tone of the image can be prevented from being changed due to the color of the to-be-transferred material in an unintentional manner without using the white ink excessively. Also when white ink is used in order to prevent the color tone of the to-be-transferred material from being seen through, for example, the drying performance is increased, and a desired level of quality is achieved.

In a similar manner to the above description of the first embodiment, in the present embodiment, it is desired that the controller read the image parameter in a certain area, perform a threshold determination, and control the amount of the white ink to be discharged and adhered. As the amount of the white ink to be adhered in a certain area is adjusted, a minimum amount of white ink to prevent the color tone of the to-be-transferred material from being seen through in a certain area is applied, and the white ink usage in a certain area can appropriately be adjusted. Accordingly, the white ink usage can be reduced, and favorable results can be obtained from the viewpoint of reducing the cost. As the amount of the white ink to be adhered in a certain area is adjusted, an undesired ink flow can be handled easily.

### Fifth Embodiment

In the above description of the fourth embodiment, a pair of neighboring areas are compared with each other, and the amount of the ink to be adhered is adjusted such that the difference in the total amount of the ink to be adhered between a pair of neighboring areas will be small. In other words, in the above description of the fourth embodiment, the amount of the ink to be adhered is adjusted in a similar manner to the above description of the second embodiment. According to the present embodiment, the ink can be prevented from flowing even when the DTF printing is adopted.

In the present embodiment, the medium in the above description of the third embodiment and the above description of the fourth embodiment is read as a to-be-transferred material where appropriate. Redundant descriptions of the same matters as those described above may be omitted in the following description.

The above description with reference to, for example, FIG. 7, FIG. 8, and FIG. 9 is applicable to the present embodiment. For example, in order to reduce the difference in the total amount of the ink to be adhered between a pair of neighboring areas, the amount of the ink to be adhered at the boundary between a pair of neighboring areas is adjusted to appear in gradation. Alternatively, invisible ink may be applied. When invisible ink is to be applied, it is desired that the amount of the adhesion of the invisible ink be adjusted.

In the present embodiment, gradation processing is performed as follows. The controller calculates the total amount of the ink to be adhered, which indicates the sum total of the amounts of all the kinds of ink to be adhered, in a certain area. When the difference in the total amount of the ink to be adhered between a pair of neighboring areas is equal to or greater than a predetermined threshold, the amount of the color ink to be adhered is adjusted such that the difference in the total amount of the ink to be adhered between a pair of neighboring areas will be smaller than a predetermined threshold.

Alternatively, in the present embodiment, the discharge device discharges invisible ink, and the controller calculates the total amount of the ink to be adhered, which indicates the sum total of the amounts of all the kinds of ink to be adhered, in a certain area. When the difference in the total amount of the ink to be adhered between a pair of neighboring areas is equal to or greater than a predetermined threshold, the amount of the invisible ink to be adhered is adjusted such that the difference in the total amount of the ink to be adhered between a pair of neighboring areas will be smaller than a predetermined threshold.

Aspects of the present disclosure are, for example, as follows.

### First Aspect

A printing system includes a discharge device to discharge color ink and white ink to a medium and a controller to control the discharge device. The printing system obtains image data, color data of the medium, and density data of the white ink. The controller calculates a concealment ratio of the medium based on the color data of the medium and the density data of the white ink, and calculates an amount of the white ink to be adhered to conceal the medium based on the calculated concealment ratio. The controller reads an image parameter given below in the image data, and performs a threshold determination for the read image parameter, and adjusts the amount of the white ink to be adhered based on a result of the threshold determination.

### Image Parameter

The image parameter is at least one image parameter selected from an amount of the color ink to be adhered and the color data measurable by a colorimeter.

### Second Aspect

A printing system includes a discharge device to discharge color ink and white ink to a transfer base material and a controller to control the discharge device. The color ink and the white ink discharged to the transfer base material are transferred to a to-be-transferred material, and the printing system obtains image data, color data of the to-be-transferred material, and density data of the white ink. The controller calculates a concealment ratio of the to-be-transferred material based on the color data of the to-be-transferred material and the density data of the white ink, and calculates an amount of the white ink to be adhered to conceal the to-be-transferred material based on the calculated concealment ratio. The controller reads an image parameter given below in the image data, and performs a threshold determination for the read image parameter, and adjusts the amount of the white ink to be adhered based on a result of the threshold determination.

### Image Parameter

The image parameter is at least one image parameter selected from an amount of the color ink to be adhered and the color data measurable by a colorimeter.

### Third Aspect

In the printing system according to the first aspect or the second aspect, the color data is spectral reflectance, spectral transmittance, brightness, color saturation, or density.

### Fourth Aspect

In the printing system according to the first aspect or the second aspect, the image parameter is the amount of the color ink to be adhered, and the controller determines whether the amount of the color ink to be adhered is equal to or greater than a first threshold. When the amount of the color ink to be adhered is equal to or greater than the first threshold, the white ink is discharged at a prescribed lower limit of the amount of the white ink to be adhered.

### Fifth Aspect

In the printing system according to the first aspect or the second aspect, the image parameter is the color data, and the controller determines whether the color data is equal to or smaller than a second threshold. When the color data is equal to or smaller than the second threshold, the white ink is discharged at the calculated amount of the white ink to be adhered.

### Sixth Aspect

In the printing system according to any one of the first aspect to the fifth aspect, the controller reads the image parameter in a certain area to perform a threshold determination, and controls the amount of the white ink to be discharged and adhered.

### Seventh Aspect

In the printing system according to any one of the first aspect to the sixth aspect, the controller calculates a total amount of the color ink to be adhered and the white ink to be adhered, which indicates a sum total of amounts of all kinds of ink to be adhered, in a certain area. When a difference in the total amount of the ink to be adhered between a pair of neighboring areas is equal to or greater than a prescribed threshold, the controller adjusts the amount of the color ink to be adhered to decrease the difference to be smaller than a prescribed threshold, and performs gradation processing

### Eighth Aspect

In the printing system according to any one of the first aspect to the sixth aspect, the discharge device discharges invisible ink. The controller calculates a total amount of the color ink to be adhered and the white ink to be adhered, which indicates a sum total of amounts of all kinds of ink to be adhered, in a certain area. When a difference in the total amount of the ink to be adhered between a pair of neighboring areas is equal to or greater than a prescribed threshold, the controller adjusts an amount of the invisible ink to be adhered to decrease the difference to be smaller than the prescribed threshold.

### Ninth Aspect

In the printing system according to the first aspect, the white ink is used as a foundation after an image is formed on the medium, and the controller performs a threshold determination based on the image parameter, and controls the amount of white ink to be adhered that serves as the foundation.

### Tenth Aspect

In the printing system according to the second aspect, the white ink is used as a foundation after ink is transferred to the to-be-transferred material, and the controller performs a threshold determination based on the image parameter, and controls the amount of the white ink to be adhered that serves as the foundation.

### Eleventh Aspect

A printer includes a discharge device to discharge color ink and white ink to a medium and a controller to control the discharge device. The printer obtains image data, color data of the medium, and density data of the white ink. The controller calculates a concealment ratio of the medium based on the color data of the medium and the density data of the white ink, and calculates an amount of the white ink to be adhered to conceal the medium based on the calculated concealment ratio. The controller reads an image parameter given below in the image data, and perform a threshold determination for the read image parameter. The controller adjusts the amount of the white ink to be adhered based on a result of the threshold determination.

### Image Parameter

The image parameter is at least one image parameter selected from an amount of the color ink to be adhered and the color data measurable by a colorimeter.

### Twelfth Aspect

A printer includes a discharge device to discharge color ink and white ink to a transfer base material and a controller to control the discharge device. The color ink and the white ink discharged to the transfer base material are transferred to a to-be-transferred material, and the printer obtains image data, color data of the to-be-transferred material, and density data of the white ink. The controller calculates a concealment ratio of the to-be-transferred material based on the color data of the to-be-transferred material and the density data of the white ink, and calculates an amount of the white ink to be adhered to conceal the to-be-transferred material based on the calculated concealment ratio. The controller reads an image parameter given below in the image data, and perform a threshold determination for the read image parameter. The controller adjusts the amount of the white ink to be adhered based on a result of the threshold determination.

### Image Parameter

The image parameter is at least one image parameter selected from an amount of the color ink to be adhered and the color data measurable by a colorimeter.

### Thirteenth Aspect

A printing method includes discharging, using a printer, color ink and white ink to a medium and controlling discharge of the color ink and the white ink. The printing method includes obtaining image data, color data of the medium, and density data of the white ink. The controlling includes calculating a concealment ratio of the medium based on the color data of the medium and the density data of the white ink, calculating an amount of the white ink to be adhered to conceal the medium based on the calculated concealment ratio, reading an image parameter given below in the image data, performing a threshold determination for the read image parameter, and adjusting the amount of the white ink to be adhered based on a result of the threshold determination.

### Image Parameter

The image parameter is at least one image parameter selected from an amount of the color ink to be adhered and the color data measurable by a colorimeter.

### Fourteenth Aspect

A printing method, which uses a printer, includes discharging color ink and white ink to a transfer base material and controlling discharge of the color ink and the white ink. The color ink and the white ink discharged to the transfer base material are transferred to a to-be-transferred material. In the printing method, image data, color data of the to-be-transferred material, and density data of the white ink are obtained. The controlling includes calculating a concealment ratio of the to-be-transferred material based on the color data of the to-be-transferred material and the density data of the white ink, and calculating an amount of the white ink to be adhered to conceal the to-be-transferred material based on the calculated concealment ratio. The controlling further includes reading an image parameter given below in the image data, performing a threshold determination for the read image parameter, and adjusting the amount of the white ink to be adhered based on a result of the threshold determination.

### Image Parameter

The image parameter is at least one image parameter selected from an amount of the color ink to be adhered and the color data measurable by a colorimeter.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A printing system comprising:
a discharge device to discharge color ink and white ink to a medium;
a controller to control the discharge device; and
circuitry configured to obtain image data, color data of the medium, and density data of the white ink,
wherein the controller
calculates a concealment ratio of the medium based on the color data of the medium and the density data of the white ink,
calculates an amount of the white ink to be adhered to conceal the medium based on the calculated concealment ratio,
reads at least one image parameter selected from an amount of the color ink to be adhered and the color data measurable by a colorimeter in the image data,
performs a threshold determination for the read image parameter, and
adjusts the amount of the white ink to be adhered based on a result of the threshold determination.

2. A printing system comprising:
a discharge device to discharge color ink and white ink to a transfer base material, the color ink and the white ink discharged to the transfer base material transferred to a to-be-transferred material, and
a controller to control the discharge device; and
circuitry configured to obtain image data, color data of the to-be-transferred material, and density data of the white ink,
wherein the controller
calculates a concealment ratio of the to-be-transferred material based on the color data of the to-be-transferred material and the density data of the white ink,
calculates an amount of the white ink to be adhered to conceal the to-be-transferred material based on the calculated concealment ratio,
reads at least one image parameter selected from an amount of the color ink to be adhered and the color data measurable by a colorimeter in the image data,
performs a threshold determination for the read image parameter, and
adjusts the amount of the white ink to be adhered based on a result of the threshold determination.

3. The printing system according to claim 1,
wherein the color data is spectral reflectance, spectral transmittance, brightness, color saturation, or density.

4. The printing system according to claim 1,
wherein the image parameter is the amount of the color ink to be adhered,
wherein the controller determines whether the amount of the color ink to be adhered is equal to or greater than a first threshold, and
wherein when the amount of the color ink to be adhered is equal to or greater than the first threshold, the white ink is discharged at a prescribed lower limit of the amount of the white ink to be adhered.

5. The printing system according to claim 1,
wherein the image parameter is the color data,
wherein the controller determines whether the color data is equal to or smaller than a second threshold, and
wherein the white ink is discharged at the calculated amount of the white ink to be adhered when the color data is equal to or smaller than the second threshold.

6. The printing system according to claim 1,
wherein the controller reads the image parameter in a certain area to perform the threshold determination, and controls the amount of the white ink to be discharged and adhered.

7. The printing system according to claim 1,
wherein the controller calculates a total amount of the color ink to be adhered and the white ink to be adhered, which indicates a sum total of amounts of all kinds of ink to be adhered, in a certain area, and
wherein when a difference in the total amount of the ink to be adhered between a pair of neighboring areas is equal to or greater than a prescribed threshold, the controller adjusts the amount of the color ink to be adhered to decrease the difference to be smaller than the prescribed threshold, and performs gradation processing.

8. The printing system according to claim 1,
wherein the discharge device discharges invisible ink,
wherein the controller calculates a total amount of the color ink to be adhered and the white ink to be adhered, which indicates a sum total of amounts of all kinds of ink to be adhered, in a certain area, and
wherein when a difference in the total amount of the ink to be adhered between a pair of neighboring areas is equal to or greater than a prescribed threshold, the controller adjusts an amount of the invisible ink to be adhered to decrease the difference to be smaller than the prescribed threshold.

9. The printing system according to claim 1,
wherein the white ink is used as a foundation after an image is formed on the medium, and
wherein the controller performs a threshold determination based on the image parameter, and controls the amount of the white ink to be adhered that serves as the foundation.

10. The printing system according to claim 2,
wherein the white ink is used as a foundation after ink is transferred to the to-be-transferred material, and
wherein the controller performs a threshold determination based on the image parameter, and controls the amount of the white ink to be adhered that serves as the foundation.

11. A printing method comprising:
discharging color ink and white ink to a medium;
controlling discharge of the color ink and the white ink;
obtaining image data, color data of the medium, and density data of the white ink;
calculating a concealment ratio of the medium based on the color data of the medium and the density data of the white ink;
calculating an amount of the white ink to be adhered to conceal the medium based on the calculated concealment ratio;
reading at least one image parameter selected from an amount of the color ink to be adhered and the color data measurable by a colorimeter in the image data;
performing a threshold determination for the read image parameter; and
adjusting the amount of the white ink to be adhered based on a result of the threshold determination.
